(19) United States
(12) Patent Application Publication
(10) Pub. No.: US 2010/0103452 A1
(43) Pub. Date: Apr. 29, 2010

(54) METHOD AND APPARATUS FOR CREATING PAGE DESCRIPTION LANGUAGE DATA FOR PARALLEL PROCESSING

(75) Inventors: Sun-il CHOI, Uiwang-si (KR); Jung-kil KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/576,348

(22) Filed: Oct. 9, 2009

(30) Foreign Application Priority Data
Oct. 27, 2008 (KR) 10-2008-0105483

(51) Int. Cl. G06F 15/00

(52) U.S. Cl. 358/1.15

(57) ABSTRACT

Provided is a method and apparatus of creating printing data, the method includes: classifying a plurality of objects that are to be printed into a plurality of groups; generating a page description language (PDL) section for each group to include commands for establishing attributes that are to be used in their respective group; and creating PDL data for the objects by combining the PDL sections.

### CROSS-REFERENCE TO RELATED PATENT APPLICATION

This application claims priority from Korean Patent Application No. 10-2008-0105483, filed on Oct. 27, 2008, in the Korean Intellectual Property Office, the disclosure of which is incorporated herein by reference in its entirety.

### BACKGROUND OF THE INVENTION

1. Field of the Invention

Apparatuses and methods consistent with the present invention related to creating page description language (PDL) data to be processed by a printer device.

2. Description of the Related Art

Printers use various types of printing data according to manufacturing companies and printing types to obtain images that are to be output from a host such as a PC.

In general, printing data is expressed using a page description language (PDL). A PDL describes an image of a page that is to be printed and is used by an application program, such as an illustrator, with a printer. Various PDLs, for example, PCL5e, PCL XL, Postcript, PCL-GUI, PCLXL, HPGL, ESC/P2, ESC/PAGE, and ESC/PAGE-COLOR, are used according to characteristics of a printing job and a printer printing the printing job.

FIGS. 1A and 1B are diagrams for explaining a method of creating PDL data in the related art. FIG. 1A is a diagram illustrating a page that is to be printed. FIG. 1B illustrates conventional PDL data corresponding to the page illustrated in FIG. 1A. Referring to FIG. 1B, moveto and changeColor are commands for changing attributes of an object, and drawStar, drawCircle, drawHexagon, drawTriangle, drawRectangle, and drawEllipse are each a drawing command for drawing a respective object onto the page. In this regard, attributes are information indicating characteristics of the objects, such as font, line width, etc., and are used in processing the drawing commands.

The PDL data of the related art shown in FIG. 1B is converted into a bitmap image through raster image processing. In more detail, a start point moves to a location 100 50 according to a first command line, a color attribute that determines the color of an object to be drawn is changed to yellow according to a second command line, and a circle having a size of 100 is drawn according to a third command line. Then, a red circle is drawn at a location 110 150, and a red hexagon is drawn at a location of 300 250.

As described above, a plurality of commands used to express the objects are sequentially processed, line by line, in order to create the PDL data of the related art shown in FIG. 1B. However, the PDL data shown in FIG. 1B does not fully utilize the function of a printer that includes a multi core and multi processor and that supports parallel processing since a printer supporting parallel processing sequentially processes the objects instead.

### SUMMARY OF THE INVENTION

The present invention provides a method and apparatus for creating printing data by which a printer can process objects in parallel. The printer then outputs an image of a page on a recording medium, (e.g., paper and the like) according to the PDL output from the apparatus to the printer.

According to an aspect of the present invention, there is provided a method of creating printing data, the method including classifying a plurality of objects that are to be printed into a plurality of groups; generating a page description language (PDL) section for each group including commands for establishing attributes that are to be used in each respective group; and creating PDL data for the plurality of objects by combining the PDL sections.

The creating of the PDL data may include: when a first command included in a PDL section representing a first group is to be processed after a second command included in a PDL section representing a second group, inserting reference information indicating a dependency between the first command and the second command into a first command line.

The inserting of the reference information may include: allocating command numbers to all command lines of the PDL data without redundancy among the allocated command numbers; and inserting a command number of the second command into the first command line.

The classifying of the plurality of objects may include: determining the number of groups based on a performance profile of a printer.

The classifying of the plurality of objects may include: classifying the objects in such a way as to minimize dependencies between the groups according to an order of drawing the objects.

According to another aspect of the present invention, there is provided a computer-readable medium having a program recorded thereon for causing a computer to execute the method of creating printing data. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like.

According to another aspect of the present invention, there is provided an apparatus for creating printing data, the apparatus including: an object classifying unit which classifies a plurality of objects that are to be printed into a plurality of groups; a PDL section generating unit which generates a PDL section for each group to include commands for establishing attributes that are to be used in their respective group; and a PDL data generating unit which combines the PDL sections generated by the PDL section generating unit and creates PDL data for the plurality of objects. The apparatus may be a computer connected to a printer, or may be part of the printer itself.

The PDL data generating unit, when a first command included in a PDL section representing a first group is to be processed after a second command included in a PDL section representing a second group, may insert reference information indicating a dependency between the first command and the second command into a first command line.

The PDL data generating unit may include: a number allocating unit which allocates command numbers to all command lines of the PDL data without redundancy among the allocated command numbers; and a reference information inserting unit which inserts a command number of the command line comprising the second command into the first command line.

The object classifying unit may determine the number of groups based on a performance profile of a printer.

The object classifying unit may classify the objects in such a way as to minimize dependencies between the groups according to an order of drawing the objects.

### BRIEF DESCRIPTION OF THE DRAWINGS

The above and/or other aspects of the present invention will become more apparent by describing in detail exemplary embodiments thereof with reference to the attached drawings in which:

FIGS. 1A and 1B are diagrams for explaining a method of creating page description language (PDL) data in the related art;

FIG. 2 is a flowchart illustrating a method of creating PDL data, according to an exemplary embodiment of the present invention;

FIG. 3 is a diagram illustrating dependencies between a plurality of objects, according to an exemplary embodiment of the present invention;

FIGS. 4A and 4B are diagrams for explaining a method of creating PDL data, according to an exemplary embodiment of the present invention;

FIGS. 5A and 5B are diagrams for explaining a method of creating PDL data, according to another exemplary embodiment of the present invention; and

FIG. 6 is a block diagram of an apparatus for creating PDL data, according to an embodiment of the present invention.

### DETAILED DESCRIPTION OF THE INVENTION

Hereinafter, exemplary embodiments of the present invention will be described more fully with reference to the accompanying drawings, in which exemplary embodiments of the invention are shown.

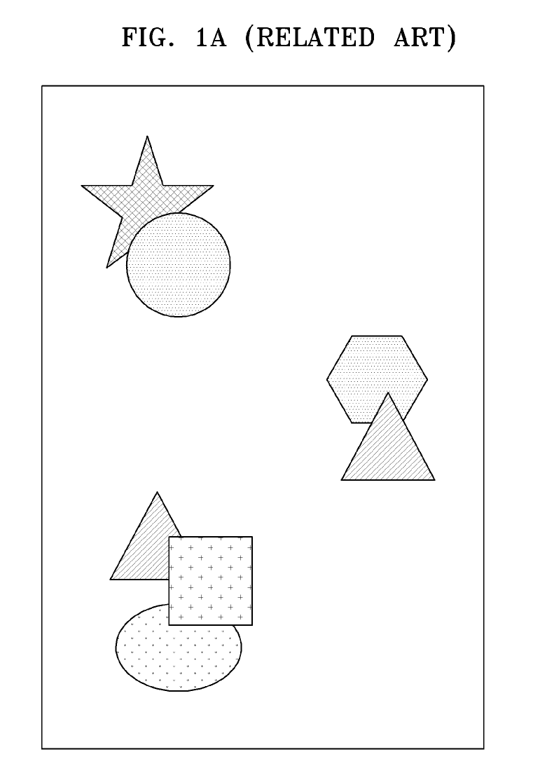

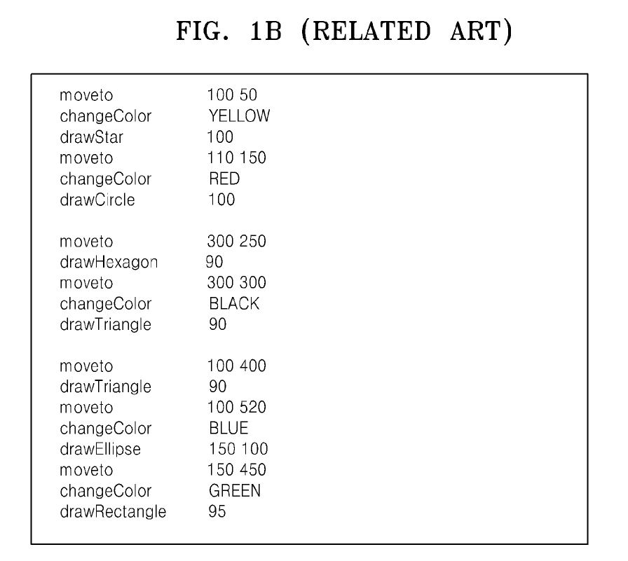

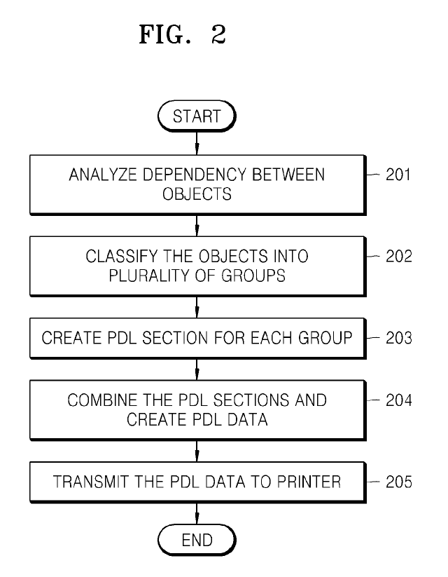

FIG. 2 is a flowchart illustrating a method of creating page description language (PDL) data, according to an exemplary embodiment of the present invention. Referring to FIG. 2, in operation 201, dependencies between a plurality of objects that are to be printed are analyzed. The dependencies represent relationships in terms of attributes of the objects or drawing. For example, since a star object needs to be drawn before a circle object with reference to FIG. 1A, a dependency between the two objects exists. Since the circle object and a hexagon object have the same color attribute, that is, RED, a dependency between the two objects exists.

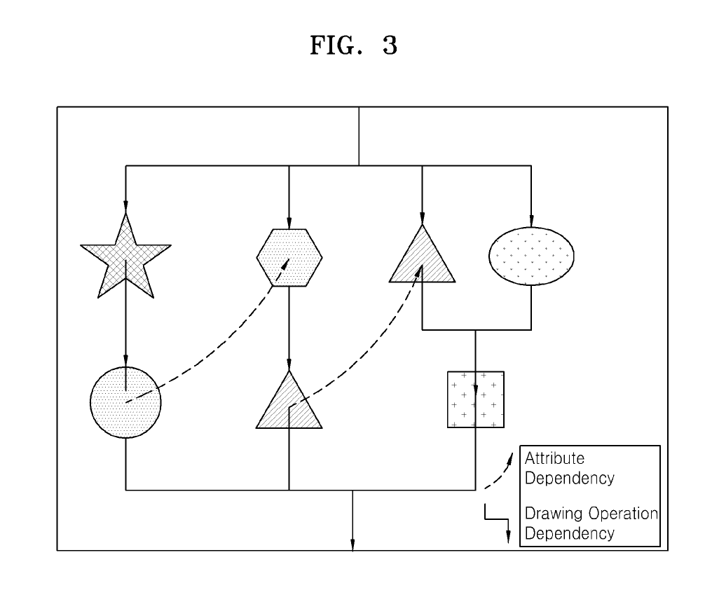

An apparatus for creating printing data according to an exemplary embodiment of the present invention may use a diagram in order to analyze dependencies between objects. FIG. 3 is a diagram illustrating the dependencies between the objects shown in FIG. 1A.

Referring to FIG. 3, since the circle and hexagon objects shown in FIG. 1A have the same color attribute with respect to each other, and two triangles shown in FIG. 1A have the same color attribute with respect to each other, an attribute dependency between each of the object pairs exists. Also, a drawing order dependency between the four objects exists according to the order of drawing the four objects. According, objects may be dependent upon one another based on an attribute dependency and/or a drawing operation dependency. Thus, the diagram in FIG. 3 illustrates the dependencies between the objects shown in FIG. 1A.

Referring to FIG. 2, in operation 202, the objects shown in FIG. 1A are classified into a plurality of groups to create independent PDL data for each group so that a printer can process each group in parallel. Thus, the number of groups may be determined based on a performance profile of the printer. Also, the objects may be classified in such a way as to minimize the drawing order of dependencies between the groups.

Various algorithms may be used to classify the objects into groups according to various realization methods, and thus, the present invention is not limited to a specific algorithm.

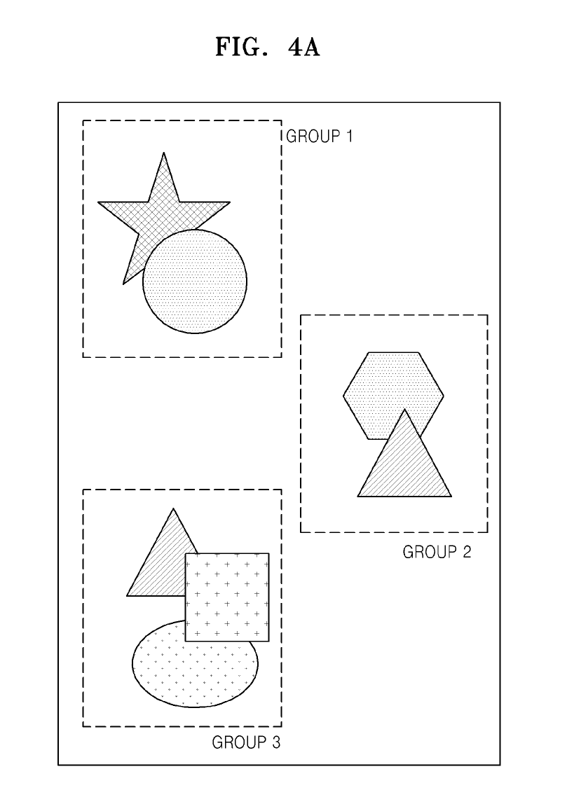

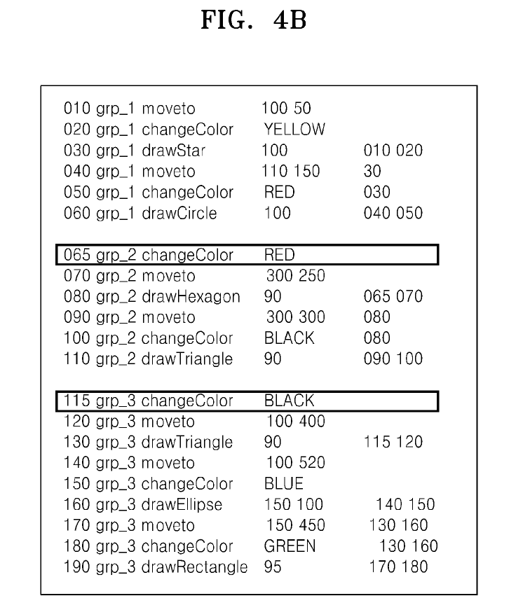

In operation 203, independent PDL data for each group is created. Hereinafter, the independent PDL data created for each group is referred to as a PDL section. Since the PDL sections need to be processed independently, i.e., in parallel, the PDL section for each group must include commands for establishing attributes that are to be used in their respective group. This will be described in more detail with reference to FIGS. 4A and 4B later.

In operation 204, PDL data is created by combining the PDL sections. Thereafter, the PDL data is transmitted to the printer in operation 205. The PDL data is final PDL data used to print all the objects in the printer. If the PDL sections are processed independently of each other, an order of drawing objects belonging to different groups may not be followed. Thus, when a first command included in a PDL section representing a first group is to be processed after a second command included in a PDL section representing a second group, reference information indicating the dependency between the first command and the second command is inserted into a first command line so that the printer may check that the second command has been completely processed before processing the first command.

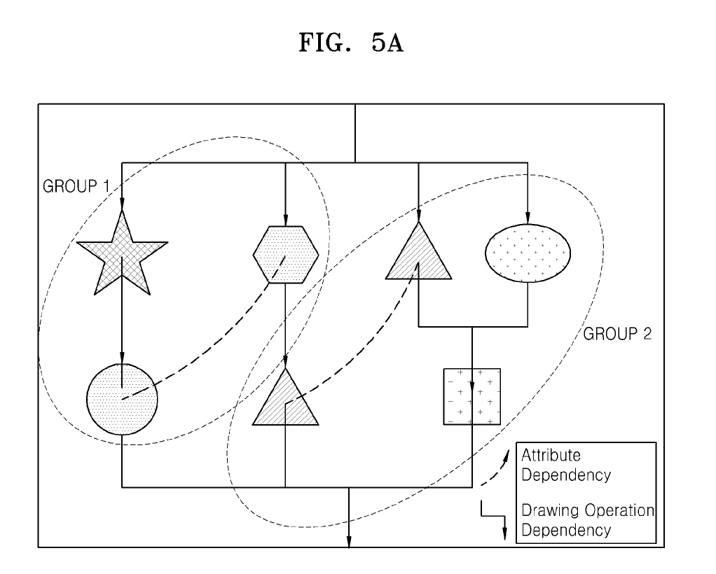

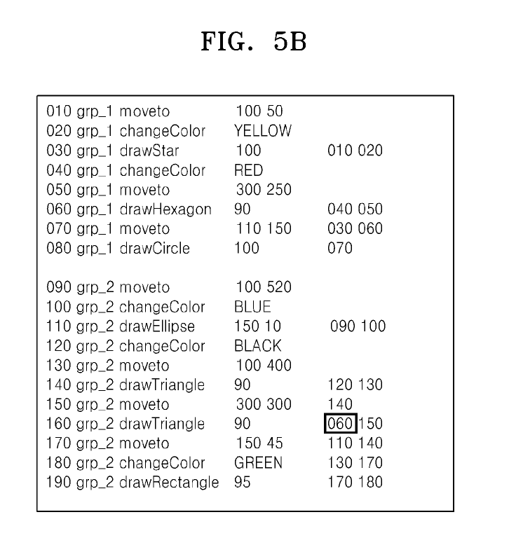

The reference information may be defined by a new command. Alternatively, command numbers may be allocated to each command of the PDL data, and a command number corresponding to the second command may be inserted into the first command line. The latter will be described in more detail with reference to FIGS. 5A and 5B.

FIGS. 4A and 4B are diagram for explaining a method of creating PDL data, according to an exemplary embodiment of the present invention. FIG. 4A is a diagram illustrating how to classify the objects shown in FIG. 1A into three groups. FIG. 4B is a diagram describing PDL data for the objects according to the three groups illustrated in FIG. 4A.

Compared to FIG. 1B, referring to FIG. 4B, command numbers (e.g., 010, 020, 030, etc.) are allocated to each command line, and a group index grp_1 is inserted into command lines of a PDL section representing a first group 1, a group index grp_2 is inserted into command lines of a PDL section representing a second group 2, and a group index grp_3 is inserted into command lines of a PDL section representing a third group 3. A command number corresponding to a command having a dependency with a corresponding command is inserted into each command line as reference information. For example, a printer must check if commands corresponding to command numbers 040 and 050 have been processed in order to process a command corresponding to command number 060. If commands corresponding to command numbers 040 and 050 have not yet been processed, the printer must wait until these commands have been processed before proceeding with processing the command corresponding to command number 060.

Meanwhile, the PDL data shown in FIG. 4B further includes command lines corresponding to command numbers 065 and 115 compared to the PDL data shown in FIG. 1B. Commands corresponding to the command numbers 065 and 115 are used to remove attribute dependencies between each group.

For example, if the PDL section representing the second group is processed independently from the PDL section representing the first group without the commands corresponding to command numbers 065 and 115, the printer does not know a color attribute used in a command corresponding to command number 080 to draw a hexagon object. This does not occur in the PDL data shown in FIG. 1B. Since all command lines of the PDL data shown in FIG. 1B are processed sequentially, the printer initializes RED as the color attribute according to the command corresponding to the command number 50 to draw the hexagon according to the command corresponding to the command number 080.

Therefore, the command corresponding to the command number 065 is included in the PDL data shown in FIG. 4B in order to initialize the color attribute of the PDL section representing the second group 2. In the same manner, the command corresponding to the command number 115 is included in the PDL data shown in FIG. 4B in order to initialize the color attribute of the PDL section representing the third group 3.

The PDL data shown in FIG. 4B makes it possible to process the PDL sections independently, so that a printer supporting parallel processing can quickly perform a printing job.

FIGS. 5A and 5B are diagrams for explaining a method of creating PDL data, according to another exemplary embodiment of the present invention. Referring to FIG. 5A, the objects shown in FIG. 1A are classified into two groups, unlike in FIG. 4A. The PDL data for the objects according to the two group may be the same as illustrated in FIG. 4B.

When the objects shown in FIG. 1A are classified into two groups, a dependency not occurring in FIG. 4A between the objects exists. In more detail, since a hexagon drawn according to a command included in a first group 1 is drawn before a lower triangle drawn according to a command included in a second group 2, a drawing order dependency between the two objects exists. Thus, a PDL section representing the second group 2 cannot be completely processed from a PDL section representing the first group 1 independently. A printer must check if the hexagon drawn according to a command included in the first group 1 has been processed before processing the lower triangle drawn according to a command included in the second group 2.

Therefore, the command number 060 is inserted into a command line corresponding to command number 160 for drawing the lower triangle of the PDL section representing the second group 2 as reference information so that the printer can check if the command corresponding to the command number 060 for drawing the hexagon has been completely processed before processing the command corresponding to the command number 160.

In the present exemplary embodiment, each PDL section representing an object group is generated to increase the speed of a printing job of a printer, and information about dependencies between objects is inserted into the PDL data to prevent an error caused by an inverse processing order.

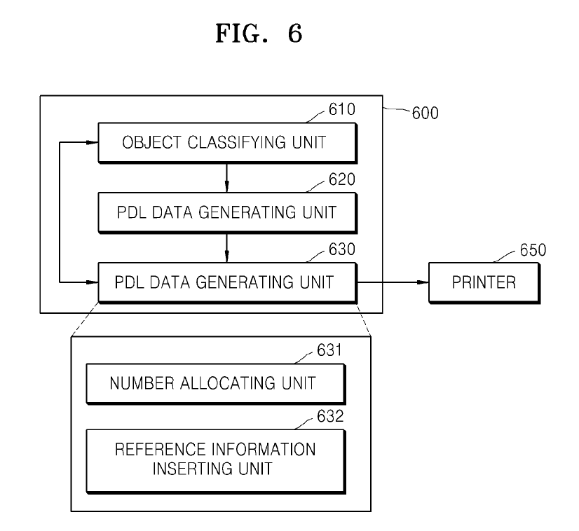

FIG. 6 is a block diagram of an apparatus 600 for creating PDL data, according to an exemplary embodiment of the present invention. Referring to FIG. 6, the apparatus 600 for creating PDL data includes an object classifying unit 610, a PDL section generating unit 620, and a PDL data generating unit 630. The apparatus may be a computer connected to a printer, or may be part of the printer itself including a plurality of processing devices.

The object classifying unit 610 classifies a plurality of objects that are to be printed by a printer 650 into a plurality of groups. The number of groups may be determined based on a performance profile of the printer 650. For example, the number of groups may be determined according to the number of processors included in the printer 650. Thus, the object classifying unit 610 may obtain printer information from printer 650, including a number of processors included therein, and determine a number of groups according to the received printer information. Also, the object classifying unit 610 may classify the objects in such a way as to minimize drawing order dependencies between the groups.

The PDL section generating unit 620 generates a PDL section for each group to include commands for establishing attributes that are to be used in their respective group.

The PDL data generating unit 630 combines the PDL sections generated by the PDL section generating unit 620 and creates final PDL data. Thereafter, the PDL data generating unit 630 transmits the final PDL data to the printer 650 for processing the final PDL data and printing an image. In this regard, when a first command included in a PDL section representing a first group is to be processed after a second command included in a PDL section representing a second group, reference information indicating a dependency between the first command and the second command is inserted into a first command line. As described above, the reference information may be a command number corresponding to a command line or may be a newly defined command. In the present exemplary embodiment, command numbers are used as the reference information.

The PDL data generating unit 630 includes a number allocating unit 631 and a reference information inserting unit 632. The number allocating unit 631 allocates a command number to each command line of the PDL data. When the first command included in the PDL section representing the first group is to be processed after the second command included in the PDL section representing the second group, the reference information inserting unit 632 inserts reference information indicating the dependency between the first command and the second command into the first command line.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of creating printing data, the method comprising:
classifying a plurality of objects into a plurality of groups;
generating, by a page description language (PDL) section generating unit, a plurality of PDL sections including commands for establishing attributes that are used in each of the plurality of groups; and
creating PDL data for the plurality of objects by combining the plurality of PDL sections,
wherein one of the plurality of PDL sections corresponds to one of the plurality of groups.

2. The method of claim 1, wherein the creating of the PDL data comprises:
when a first command included in a first PDL section of the plurality of PDL sections representing a first group of the plurality of groups follows in a processing order a second command included in a second PDL section of the plurality of PDL sections representing a second group of the plurality of groups, inserting reference information indicating a dependency between the first command and the second command into a first command line.

3. The method of claim 2, wherein the inserting of the reference information comprises:
allocating command numbers to all command lines of the PDL data without redundancy among the allocated command numbers; and
inserting a command number of the second command into the first command line.

4. The method of claim 1, wherein the classifying of the plurality of objects comprises: determining a number of groups of the plurality of groups based on a performance profile of a printer.

5. The method of claim 1, wherein the classifying of the plurality of objects comprises: classifying the plurality of objects to minimize dependencies between the plurality of groups according to an order of drawing the plurality of objects.

6. A computer-readable medium having a program recorded thereon for causing a computer to execute the method of claim 1.

7. An apparatus for creating printing data, the apparatus comprising:
an object classifying unit which classifies a plurality of objects into a plurality of groups;
a page description language (PDL) section generating unit which generates a plurality of PDL sections including commands for establishing attributes that are used in each of the plurality of groups; and
a PDL data generating unit which combines the plurality of PDL sections generated by the PDL section generating unit and creates PDL data for the plurality of objects,
wherein one of the plurality of PDL sections corresponds to one of the plurality of groups.

8. The apparatus of claim 7, wherein the PDL data generating unit, when a first command included in a first PDL section of the plurality of PDL sections representing a first group of the plurality of groups follows in a processing order a second command included in a second PDL section of the plurality of PDL sections representing a second group of the plurality of groups, inserts reference information indicating a dependency between the first command and the second command into a first command line.

9. The apparatus of claim 8, wherein the PDL data generating unit comprises:
a number allocating unit which allocates command numbers to all command lines of the PDL data without redundancy among the allocated command numbers; and
a reference information inserting unit which inserts a command number of the command line comprising the second command into the first command line.

10. The apparatus of claim 7, wherein the object classifying unit determines a number of groups of the plurality of groups based on a performance profile of a printer.

11. The apparatus of claim 7, wherein the object classifying unit classifies the plurality of objects in such a way as to minimize dependencies between the plurality of groups according to an order of drawing the plurality of objects.

12. The method of claim 1, wherein the PDL data describes an entire image of a page.

13. The method of claim 2, wherein the dependency between the first command and the second command is at least one of an attribute dependency of a same attribute between two or more of the plurality of objects and a drawing order dependency of a drawing operation between the two or more of the plurality of objects.

14. The method of claim 2, wherein the first command line is a command line of the first command.

15. The method of claim 4, wherein the performance profile of the printer includes a number of processors the printer has.

16. The method of claim 7, wherein the PDL data represents an entire image of a single page.

17. A printing system comprising:
a printer; and
a page description language (PDL) creation apparatus connected to the printer, the PDL creation apparatus comprising:
an object classifying unit which classifies a plurality of objects that are to be printed into a plurality of groups;
a PDL section generating unit which generates a plurality of PDL sections, one PDL section of the plurality of PDL sections corresponding to one group of the plurality of groups, to include commands for establishing attributes that are to be used in the plurality of groups; and
a PDL data generating unit which combines the plurality of PDL sections generated by the PDL section generating unit and creates PDL data for the plurality of objects,
wherein the PDL data generating unit transmits the PDL data to the printer, and the printer processes the PDL data and outputs an image of a page on a recording medium according to the PDL data.

18. The printing system of claim 17, wherein each of the PDL sections of the plurality of PDL sections are independent of each other, and the printer, which supports parallel processing, processes each of the plurality of PDL sections in parallel with each other.

19. The printing system of claim 17, wherein the PDL data generating unit, when a first command included in a first PDL section of the plurality of PDL sections representing a first group of the plurality of groups follows in a processing order a second command included in a second PDL section of the plurality of PDL sections representing a second group of the plurality of groups, inserts reference information indicating a dependency between the first command and the second command into a first command line of the first command, and
during processing of each command line of the PDL data, the printer determines whether the second command has been completely processed before processing the first command.
